(19) United States
(12) Patent Application Publication
(10) Pub. No.: US 2009/0140938 A1
(43) Pub. Date: Jun. 4, 2009

(54) Transparent Antenna for Vehicle and Vehicle Glass With Antenna

(75) Inventors: Tatsuo Ishibashi, Kyoto-shi (JP); Shuzo Okumura, Kyoto-shi (JP); Yuki Matsui, Kyoto-shi (JP); Yoshitaka Yamaoka, Kyoto-shi (JP)

Correspondence Address: WENDEROTH, LIND & PONACK, L.L.P., 1030 15th Street, N.W.,, Suite 400 East, Washington, DC, 20005-1503, US

(73) Assignee: NISSHA PRINTING CO., LTD., Kyoto-shi, Kyoto (JP)

(21) Appl. No.: 11/887,161

(22) PCT Filed: Mar. 29, 2006
(86) PCT No.: PCT/JP2006/306515

§ 371 Date: Sep. 26, 2007

(30) Foreign Application Priority Data
Apr. 1, 2005 (JP) 2005-106527
Apr. 25, 2005 (JP) 2005-126895
May 27, 2005 (JP) 2005-155120
Jun. 1, 2005 (JP) 2005-162002

(51) Int. Cl. H01Q 1/32; H01Q 1/36

(52) U.S. Cl. 343/713; 343/897

(57) ABSTRACT

A transparent antenna for a vehicle, having transmittance property providing good visibility without worsening design and capable of realizing low resistance. The transparent antenna has an insulating sheet-like transparent base body (1a) and an antenna pattern planarly formed on the surface of the transparent base body (1a). An electrically conductive section (1b) of the antenna pattern is constructed from an electrically conductive thin film of a mesh structure, lines of each mesh are constructed from very fine bands having substantially the equal width, and the width of each of the very fine bands is 30 μm or less. The light transmittance of the antenna pattern is 70% or higher.

### TECHNICAL FIELD

The present invention relates to a transparent antenna for a vehicle to be installed to a glass face of a vehicle for receiving ground-based broadcasting and satellite-based broadcasting or transmitting and receiving radio wave and vehicle glass with an antenna.

### BACKGROUND ART

Conventionally, various film antennas to be used while being installed to a glass face of an automobile have been proposed with the popularization of car navigation systems.

A film antenna is attached to a fixed glass face. However, since a heating lines for defogger is generally wired in rear glass, the film antenna is often attached to front glass to avoid interference with the heating lines.

As this kind of film antenna, there have been proposed (a) those which are obtained by forming an antenna pattern with a metal thin wire on a transparent plastic film with electrical isolation, and (b) those which have transparency by forming a large number of fine holes on a metal foil to be an antenna by punching or the like.

However, the film antennas described in (a) has a problem that the bent metal thin wire is seen outstandingly from the inside or the outside of an automobile to not only worsen the design but also become an obstacle in driver's visibility, because of the configuration of bending and curving the wire in the antenna shape and sticking the metal thin wire to a transparent plastic film.

Further, the film antenna described in (b) is seen more outstandingly as compared with the film antenna described in (a) since a large number of holes are formed on a metal foil by punching. Moreover, whether the design of the antenna is good or bad depends on the punching accuracy of the punched holes.

If an antenna pattern is constructed from a transparent electrically conductive film used for a touch panel or the like, it is expected that an excellent design and a good driver's visibility can be assured as compared with the film antennas described in (a) and (b).

However, the transparent electrically conductive film has a characteristic that as the film thickness is made thinner and the transparency is increased more, the surface resistance, which is a measure of the conductivity, is increased more and it is therefore difficult to satisfy both of transparency which the front glass is required and low resistance which the antenna is required.

Incidentally, the resistance of a transparent electrically conductive film whose transparency is assured has a resistance of several tens to several hundreds Ω, meanwhile the resistance required for the antenna has to be a value as low as 3Ω or lower.

The present invention has been accomplished in consideration of the above-mentioned problems of conventional film antennas and an object of the present invention is to provide a transparent antenna for a vehicle having transparency for giving a good driver's visibility without worsening the design of the antenna and capable of realizing low resistance required for the antenna as well as vehicle glass with an antenna.

### DISCLOSURE OF THE INVENTION

The present invention provides a transparent antenna for a vehicle which has a sheet-like transparent substrate with an electrical isolation and an antenna pattern planarly formed on the surface of the transparent substrate. An electrically conductive part of the antenna pattern is constructed from an electrically conductive thin film of a mesh structure and outlines of each mesh are constructed from extra fine bands having substantially the equal width, and the width of each of the extra fine bands is 30 μm or less and the light transparency of the above-mentioned antenna pattern formation section is 70% or higher.

In the present invention, the above-mentioned mesh structure is constructed from planar meshes regularly continuous on a plane with the same shape and size and if a distinguishing pattern is added linearly in a plurality of meshes or in bands-like state to a plurality of mesh lines, since the light quantity passing through these meshes is damped to be less than the light quantity passing through the above-mentioned antenna pattern, the above-mentioned distinguishing pattern can be made outstanding from the antenna pattern.

The above-mentioned distinguishing pattern can be formed by making the outlines of the meshes composing the above-mentioned planar meshes wide bands or by shifting a mesh pattern being a part of the mesh structure on the mesh structure within a range not exceeding each mesh size and superposing the mesh pattern on the antenna pattern. If such a distinguishing pattern is continuously or intermittently formed on the antenna pattern, letters and designs can be formed on transparent antenna face.

In the present invention, the above-mentioned mesh structure is constructed from regularly continued planar meshes on a plane and at the same time, a gradation section may be formed in the boundary region of the antenna pattern and the antenna pattern non-formation section in the transparent substrate for decreasing brightness difference between the antenna pattern and a antenna pattern non-formation section.

The above-mentioned gradation section can be formed by partially eliminating the mesh lines of the antenna pattern in the above-mentioned boundary region or coarsening the meshes.

Further, the above-mentioned gradation section can be formed by making the elimination width of the above-mentioned mesh lines or the aperture width of the meshes longer step by step from the antenna pattern side to the antenna pattern non-formation section side.

Further, the above-mentioned gradation section can be formed also by constructing the mesh structure by arranging vertical electrically conductive wires and transverse electrically conductive wires in a lattice like state, eliminating parts of at least one of the vertical electrically conductive wires and transverse electrically conductive wires or widening the intervals of neighboring electrically conductive wires from the antenna pattern side to the antenna pattern non-formation section side.

In the present invention, the above-mentioned antenna pattern can be formed in a continuous band-like shape by partially slitting the mesh structure. In this case, however the width of the slits is controlled not to exceed the maximum mesh size.

The above-mentioned antenna pattern can be formed in meandering shape by alternately forming a plurality of slits with a prescribed length for the mesh structure in different directions. The antenna pattern can be formed by forming one slit spirally toward the center of the above-mentioned mesh structure. The maximum size of the above-mentioned meshes is preferable to be 1 mm.

In the above-mentioned transparent antenna for a vehicle, the shape of the above-mentioned meshes may be constructed to be geometric designs.

However, in the case where the lines of the meshes do not form geometric designs of extra fine bands, for example, in a case where a large number of circular holes are formed on a sheet face, even if the circular holes are arranged at the maximum density, wide width parts are formed between neighboring circular holes and not only the wide width portion are made outstandingly visible but also the light transmittance is decreased. Accordingly, the present invention excludes those of geometric designs in which the lines of the meshes are not constructed from extra fine bands even if the antenna pattern has a geometric design such as circles and ellipses.

Further, the above-mentioned antenna pattern can be constructed from a very thin metal wire made of copper or a copper alloy.

Further, it is preferable to form a transparent protection film on the surface of the above-mentioned antenna pattern.

Further, it is preferable to install electrodes for electric power supply in a part of the above-mentioned electrically conductive section and expose the electrodes by forming a through hole section in the transparent protection film corresponding to the electrodes.

It is also preferable to carry out low-reflection treatment on the surface of the above-mentioned exra fine bands.

Further, a transparent adhesive layer can be formed on a face opposite the electrically conductive section formation side of the above-mentioned transparent substrate.

The transparent antenna for a vehicle with the above-mentioned configuration of the present invention is provided with transparency property giving good driver's visibility and capable of realizing low resistance required for an antenna.

The vehicle glass with an antenna of the present invention is obtained by embedding the transparent antenna for a vehicle, equipped with electrodes for electric power supply in a part of the above-mentioned electrically conductive section and having the above-mentioned configuration, in a bonding face of laminated glass in a state in which the electrodes are projected outside.

According to the above-mentioned vehicle glass with an antenna, since a transparent antenna can be embedded in the bonding face of two glass sheets in laminated glass production process, unlike the case of disposing an antenna later, no step corresponding to the transparent antenna thickness is formed on the front glass surface and the design can be improved. Further, embedding the transparent antenna in the laminated glass makes it possible to stably maintain the antenna capability.

### BRIEF DESCRIPTION OF THE DRAWINGS

FIG. 1 is a front view showing the use state of a transparent antenna of a first embodiment of the present invention.

FIG. 2 is an enlarged view of the transparent antenna shown in FIG. 1.

FIG. 3 is a cross-sectional view along the line A-A in FIG. 2.

FIG. 4 is an enlarged view of a main part showing a basic pattern of a extra fine metal wire composing an electrically conductive section of FIG. 2.

FIG. 5 is a view equivalent to FIG. 4 showing a modified example of the antenna pattern.

FIG. 6 is a view equivalent to FIG. 4 showing another modified example of the antenna pattern.

FIG. 7 is an enlarged view of a transparent antenna of a second embodiment of the present invention.

FIG. 8 is an enlarged view of a C part in FIG. 7.

FIG. 9 is an enlarged view of a part of letter sections in FIG. 8.

FIG. 10 is an enlarged view of a letter shadow section in FIG. 8.

FIG. 11(a) to 11(c) is an explanatory drawing showing a letter-designing method by emphasis.

FIG. 12 is an explanatory drawing showing a letter-designing method by shifting the design.

FIG. 13 is an explanatory drawing showing a letter-designing method by both of emphasis and shifting the design.

FIG. 14 is an enlarged view of a transparent antenna of a third embodiment of the present invention.

FIG. 15 is a cross-sectional view along the line D-D in FIG. 14.

FIG. 16 is an enlarged view of an E part in FIG. 14.

FIG. 17 is an enlarged view of an F part in FIG. 16.

FIG. 18 is an enlarged view of a G part in FIG. 16.

FIG. 19 is an enlarged view of an H part in FIG. 16.

FIG. 20 is an explanatory drawing showing a first modification example of gradation of the third embodiment.

FIG. 21 is an explanatory drawing showing a second modification example of gradation.

FIG. 22 is an explanatory drawing showing a third modification example of gradation.

FIG. 23 is an explanatory drawing showing a fourth modification example of gradation.

FIG. 24 is a plane view of a transparent antenna of a fourth embodiment of the present invention.

FIG. 25 is an enlarged view of a J part in FIG. 24.

FIG. 26 is an explanatory drawing illustrating arrangement of slits.

FIG. 27 is an explanatory drawing illustrating the arrangement of slits.

FIG. 28 is an explanatory drawing showing the mesh shape of the antenna pattern and arrangement of slits.

FIG. 29 is an explanatory drawing showing the mesh shape of the antenna pattern and arrangement of slits.

FIG. 30 is an explanatory drawing showing the mesh shape of the antenna pattern and arrangement of slits.

FIG. 31 is an explanatory drawing showing the mesh shape of the antenna pattern and arrangement of slits.

FIG. 32 is a plane view showing a first formation pattern of slits.

FIG. 33 is a plane view showing a second formation pattern of slits.

FIG. 34 is a plane view showing a third formation pattern of slits.

FIG. 35 is a plane view showing a fourth formation pattern of slits.

FIG. 36 is a plane view showing a fifth formation pattern of slits.

### BEST MODE FOR CARRYING OUT THE INVENTION

Hereinafter, the present invention will be described in more detail along with the embodiments shown in drawings.

### (a) First Embodiment of the Invention

A transparent antenna for a vehicle (hereinafter, referred to as a transparent antenna for short) of a first embodiment is made to have transparency giving good driver's visibility and capable of realizing low resistance.

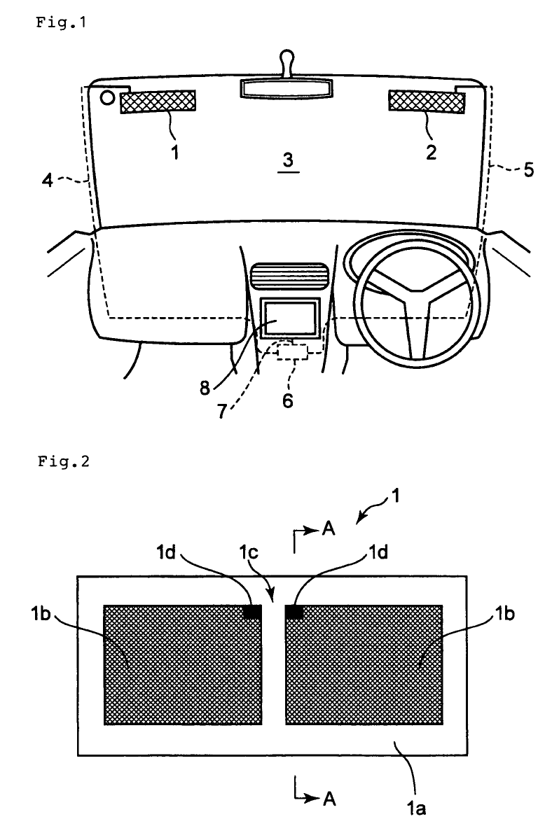

FIG. 1 shows the state that the above-mentioned transparent antenna is attached to front glass of an automobile.

In this drawing, transparent antennas 1 and 2 are installed in the upper parts of both right and left sides of front glass 3.

An antenna cord 4 is connected to the transparent antenna 1 in the left side and an antenna cord 5 is connected to the transparent antenna 2 in the right side and output terminals of the respective antenna cords 4 and 5 are connected to an amplifier unit 6 and an antenna output cord 7 led out of the amplifier unit 6 is connected to a TV tuner disposed in a monitor 8 of a car navigation system.

FIG. 2 shows an enlarged view of the transparent antenna 1. Since the transparent antenna 2 has the same configuration as that of the transparent antenna 1 and therefore, its explanation is omitted.

In FIG. 2, the transparent antenna 1 comprises a transparent plastic sheet 1a as transparent substrate with electrical isolation and a planar antenna pattern of an electrically conductive section 1b formed thereon. Further, a pair of electrodes 1d are set face to face at a gap 1c between two antenna patterns formed in a transversely long rectangular shape.

As the above-mentioned transparent plastic sheet 1a can be used transparent resin films of polycarbonates, acrylic polymers, polyethylene terephthalate, and triacetyl cellulose and also usable is sheet-like transparent glass.

The electrically conductive section 1b is formed in a planar state on approximately entire face of the transparent plastic sheet 1a, unlike a electrically conductive section formed by bending a electrically conductive wire material or a thin band in a case of a conventional antenna pattern.

The above-mentioned electrically conductive section 1b is constructed from an electrically conductive thin film with a mesh structure and has a fine mesh-like pattern constructed from a metal film of copper, nickel, aluminum, gold, silver, or the like, or an electrically conductive paste film containing metal fine particles of these metals, or a carbon paste film by photoetching of the metal thin film formed on the transparent plastic sheet 1a, or etching using printing resist, or printing a electrically conductive resin paste.

In the case where the above-mentioned antenna pattern is formed by photoetching, a photoresist film is formed on a metal film, exposed using a photo-mask, and developed using a development solution to form an antenna pattern of the resist film. Further, etching is carried out by an etching solution and the resist film is peeled and removed to form the antenna pattern with a extra fine metal wire.

Further, in the case of formation by printing resist, an antenna pattern of a resist film is printed on a metal film by screen printing, gravure printing, ink-jet method, or the like; etching the metal film other than the resist-coated part of the metal film by an etching solution, and peeling the resist film to form an antenna pattern of the metal thin film.

In the case of formation by electrically conductive paste printing, an antenna pattern is printed on a transparent substrate with an electrically conductive paste containing metal fine particles, a carbon paste, or the like to form a electrically conductive antenna pattern.

Additionally, if the surface of the extra fine metal wire formed in mesh-like pattern is subjected to low-reflection treatment, the reflection color of the metal is suppressed to make the existence of the transparent antenna 1 hardly noticeable. Accordingly, the visibility is improved in the case of seeing outside of a vehicle through the mesh-like pattern.

Practical examples of the above-mentioned low-reflection treatment may be surface treatment such as chemical conversion treatment, plating treatment, or the like. The chemical conversion treatment is for forming a low reflectance layer on the metal surface by oxidation treatment or sulfurization treatment and for example, in the case of using copper as a material for the extra fine metal wire, if an oxide coating is formed on the surface by oxidation treatment, the surface of the extra fine metal wire is turned to be black with a light reflection preventive property without decreasing the cross-sectional size of the extra fine metal wire.

Further, if black chromium plating is carried out as plating treatment to the extra fine metal wire, the surface of the extra fine metal wire is turned to be black with an antireflection property. Further, if copper plating is carried out at a high current density, the wire can be turned to be brown.

The above-mentioned electrode sections 1d are for attaching electric power supply part (not shown) of the antenna cord 4 and the electrode part 1d are constructed from square sheets electrically connected with the mesh-like pattern.

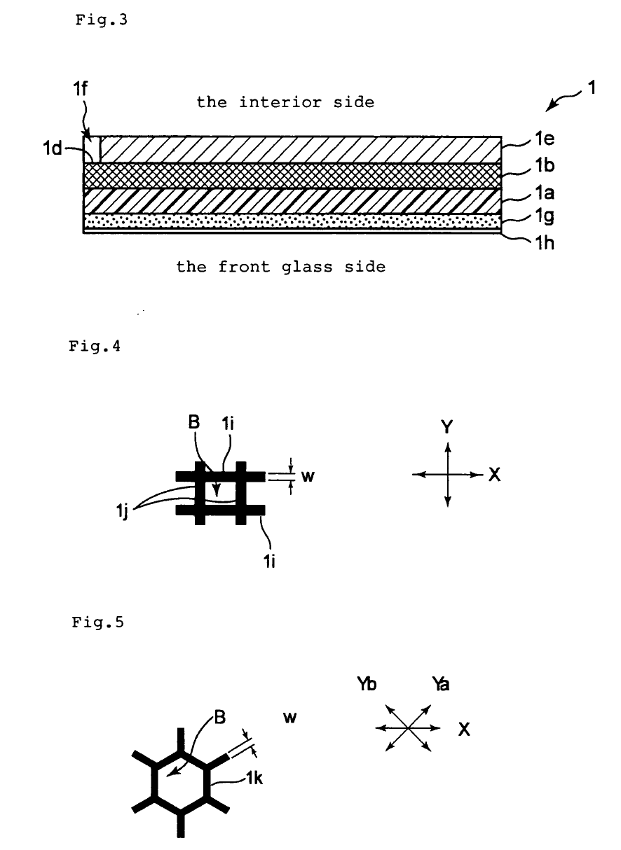

FIG. 3 is a cross-sectional view along the line A-A in FIG. 2.

An electrically conductive section 1b is formed on a transparent plastic sheet 1a and the electrically conductive section 1b is further covered with a transparent cover layer (a transparent protection film) 1e. In this manner, the electrically conductive section 1b is protected with the transparent cover layer 1e, so that it is made possible to keep stable antenna performance even if the environments, e.g. temperature or humidity, of a vehicle in which the transparent antenna 1 is disposed, are changed.

A method for forming the above-mentioned transparent cover layer 1e may include forming by sticking a transparent film to an antenna pattern of the electrically conductive section 1b using a transparent adhesive or pressure sensitive adhesive or by applying a transparent resin in a prescribed thickness to the antenna pattern.

A through hole section 1f is formed in a part of the transparent cover layer 1e and the electrode parts 1d are exposed to the through hole section 1f The above-mentioned electric power supply parts of the antenna cord 4 are stuck to the exposed electrode parts 1d.

A transparent pressure sensitive layer 1g is formed on a face opposite the electrically conductive sections 1b of the transparent plastic sheet 1a and a separating sheet 1h is formed on the surface of the transparent pressure sensitive layer 1g.

As the transparent pressure sensitive layer 1g, those without worsening the transparency of the antenna, for example, acrylic type pressure sensitive adhesive materials to be used as glue materials for smoky films which are stuck to front glass of automobiles for decreasing ultraviolet rays.

In the case where the transparent antenna 1 is to be stuck to front glass later, the above-mentioned separating sheet 1h is peeled to expose the transparent pressure sensitive adhesive layer 1g and the transparent antenna 1 is stuck to the front glass through the transparent pressure sensitive adhesive layer 1g. That is, in the case of the transparent antenna 1 shown in FIG. 3, the top face is set toward the interior side and the bottom face is set in the front glass side.

Without being limited to attach to the front glass as an extra parts, the above-mentioned transparent antenna 1 may be embedded previously in the front glass.

In the case where laminated glass is used as the front glass, the transparent antenna 1 can be sandwiched between two glass sheets in front glass manufacturing process. In this case, since the transparent antenna 1 is integrated with laminated glass, formation of the transparent pressure sensitive adhesive layer 1g is not necessarily needed. The transparent cover layer 1e may be formed based on the necessity.

FIG. 4 is an enlarged view of a part of the above-mentioned antenna pattern for showing the meshes.

The antenna pattern shown in FIG. 4 is formed in lattice type meshes of straight electrically conductive sections 1i and 1j extended in X-direction and Y-direction and is enabled to have 70% or higher light transmittance for the transparent antenna 1.

The above-mentioned light transmittance, which is a gauge of the transparency, means the total light transmittance for the total quantity of the light having entire wavelength emitted from a light source having a specified color temperature and transmitted through a sample face. If the light transmittance is lower than 70%, difference between the light transmittance of the front glass and the light transmittance of the transparent antenna 1 becomes wide to make the antenna pattern of the transparent antenna 1 seen dark. Therefore, the existence of the antenna becomes an obstacle. If it interferes in the driver's visibility of the front glass, safety is diminished.

The above-mentioned light transmittance is measured using a spectroscopic analyzer (model number NDH 2000) manufactured by Nippon Denshoku Industries Co., Ltd. However, the light transmittance 100% in an air layer is defined as the standard.

In the case where the transparent cover layer 1e is formed in the transparent antenna 1, the measurement of the light transmittance is carried out in the state that the transparent cover layer 1e is included and in the case where the transparent pressure sensitive adhesive layer 1g is formed, the measurement is carried out in the state that the transparent pressure sensitive adhesive layer 1g is included.

Further, the wire widths w of the extra fine metal wire (extra fine band) 1i in the X-direction and the extra fine metal wire (extra fine band) 1j in the Y-direction forming square-shaped outlines are adjusted to be respectively 30 μm or thinner in an uniform width. If the wire width w is thicker than 30 μm, the meshes of the antenna pattern become outstandingly visible and the design is worsened. If the wire width w is 30 μm or thinner, the existence of the antenna pattern is hardly recognized. If the film thickness of the extra fine metal wire is adjusted to give 0.5 or higher aspect ratio of the wire width/film thickness t, it is made easy to produce the antenna pattern with high precision.

In the present embodiment, the light transmittance of the transparent antenna 1 is made to keep light transmittance of 70% or higher by selecting combinations of the wire width of the above-mentioned extra fine metal wires 1i and 1j and the size of the aperture part B formed by being surrounded with these extra fine metal wires 1i and 1j.

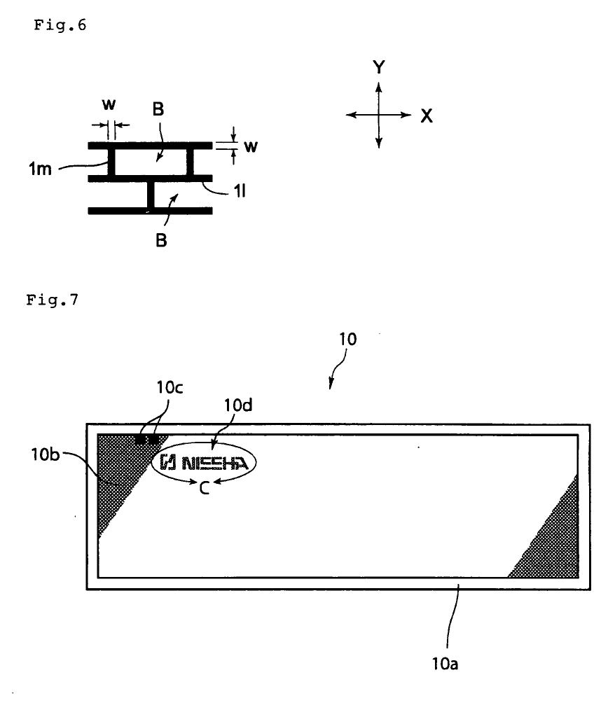

FIG. 5 and FIG. 6 show modified examples of antenna patterns.

The antenna pattern shown in FIG. 5 is made to be mesh-like shape having a hexagonal shape as a core and continuous in X-direction, Ya-direction, and Yb-direction.

The wire width w of the extra fine metal wire lk forming the outlines of the hexagon is 30 μm or thinner.

The antenna pattern shown in FIG. 6 is made to be a mesh-like shape having a ladder shape as a core and continuous in X-direction and Y-direction. The wire widths w of the extra fine metal wires 11 and l1 forming the outlines of the ladder shape are respectively 30 μm or thinner.

As described, the antenna pattern may include those having continuous rectangular shapes as a core, those having continuous polygonal shapes as a core, and those having continuous ladder shapes as a core.

Among them, those having continuous square shapes as a core are particularly preferable since it becomes hard to recognize the antenna pattern as stripes as compared with other polygonal shapes.

That is, when a pattern regularly continuing a certain shape as a core is seen, the lines tends to be seen in stripes continuous along the continuing cores (apertures). For example, in the case where a hexagonal shape forms the core, the lines of the above-mentioned extra fine bands along the continuous directions become zigzag and accordingly the lines are seemed to be thick to the extent corresponding to the fluctuation of the zigzag shape and as a result, the extra fine bands are seen in expanded state. On the other hand, in the case of those having the above-mentioned square shapes as a core, since the lines of the extra fine bands along the continuous directions become straight, there is no probability that the lines are seen thicker than the actual width and as described above, the extra fine bands are so extremely thin as 30 μm or thinner and thus the existence is hardly recognized and the antenna pattern is not seen outstandingly.

In the case of those having continuous rectangular shapes as a core, since the pitches in the longer side direction and the shorter side direction of the rectangular shape differ and therefore, if the entire body is observed, the lines are seen darker in the shorter side direction in which the pitches are shorter than in the longer side direction and they tend to be blinkingly seen just like stripes, meanwhile in the case of those having the above-mentioned square shapes as a core, such stripes do not appear and are not seen outstandingly.

The above-mentioned square shapes may include not only complete squares having stiff corners but also chamfered squares.

### EXAMPLE 1

A copper foil with a thickness of 12 μm and subjected to low-reflection treatment in both faces was stuck to a transparent polyethylene terephthalate film with a thickness of 100 μm with a transparent adhesive and an antenna pattern was produced by photoetching.

The electrically conductive section was formed to be a square mesh pattern with a line width of 15 μm and line apace pitches of 700 μm.

Next, a transparent polyethylene terephthalate cover film (a cover layer) with a thickness of 50 μm was formed on the face of the electrically conductive section having the antenna pattern by an acrylic type transparent adhesive. The electrode sections were exposed from the aperture parts which were formed by cutting a part of the cover film.

A both side-coated transparent acrylic type pressure sensitive film with a separating sheet for sticking the transparent antenna 1 to front glass is stuck to a face (rear face) opposite the electrically conductive section of the transparent polyethylene terephthalate film.

The laminate body, in which the antenna pattern was formed on the transparent polyethylene terephthalate film and then covered with the cover film, and the both side-coated transparent acrylic type pressure sensitive film with a separating sheet was stuck to the rear face of the transparent polyethylene terephthalate film, was cut in the outside along the antenna pattern to produce a transparent antenna 1.

The transparent antenna 1 produced in this manner had a light transmittance of 84%.

Two sheets of this transparent antenna 1 were prepared and the respective separating sheets were peeled off and the sheets were stuck to the right and left upper parts of front glass of an automobile.

With respect to the stuck transparent antennas 1, the existence of the antenna patterns could be scarcely recognized when being seen from the driver's sheet side and an assistant driver's sheet side and does not interfere the driver's visibility.

Next, when an antenna cord was connected to these transparent antennas 1 and the antenna cord was connected to a TV tuner of a car navigation system to receive television broadcasting, good reception state could be obtained.

### EXAMPLE 2

An antenna pattern was produced on a transparent polycarbonate film with a thickness of 100 μm by screen printing using silver paste. The electrically conductive section was made to have a hexagonal mesh pattern with line width of 30 μm and line space pitches of 700 μm in X-direction.

Next, the outside was cut along the produced antenna pattern to produce a transparent antenna 1.

The transparent antenna 1 was sandwiched in production process of laminated glass for automotive front glass while the electrode sections 1d are projected out of the glass rim portion and the front glass was assembled in an automotive frame.

When the light transmittance of the transparent antenna 1 was measured, it was 75% and the existence of the antenna pattern could be scarcely recognized when being seen from the driver's sheet side and an assistant driver's sheet side and does not interfere the driver's visibility.

When an antenna cord was connected to the above-mentioned transparent antenna 1 and the antenna cord was connected to a TV tuner of a car navigation system to receive television broadcasting, good reception state could be obtained.

### (b) Second Embodiment of the Invention

A transparent antenna of the second embodiment is enabled to have letters and designs on an antenna pattern.

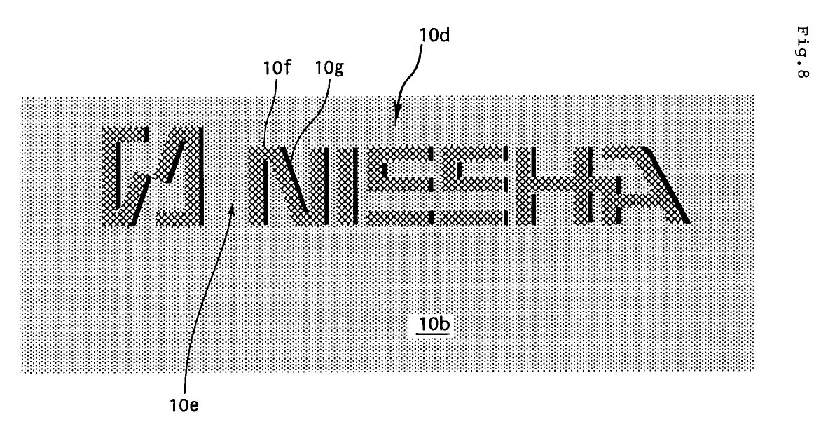

A transparent antenna 10 shown in FIG. 7 comprises an antenna pattern as a electrically conductive section 10b planarly formed on a transparent plastic sheet 10a as an electrically insulating transparent substrate and an antenna terminal 10c is formed in the left upper part of the antenna pattern formed transversely long rectangular shape.

Reference symbol 10d shows logo designed on the transparent antenna 10 and the formation method of the logo will be described later.

The above-mentioned transparent plastic sheet 10a is made of the same material as that of the transparent plastic sheet 1a shown in FIG. 2 and the above-mentioned electrically conductive section 10b is also made of the same material as that of the electrically conductive section 1b and has the same configuration.

The above-mentioned antenna terminal 10c is for sticking the electric power supply part (not shown) of the antenna cord 4 and the antenna terminal 10c is constructed from a square sheet electrically connected with the mesh-like pattern.

FIG. 8 is an enlarged view of a C part in FIG. 7.

The logo 10d was formed on the mesh section 10e constructed from the electrically conductive section 10b and constructed by combining a letter part 10f and a letter shadow section 10g showing the shadow of the letter part 10f.

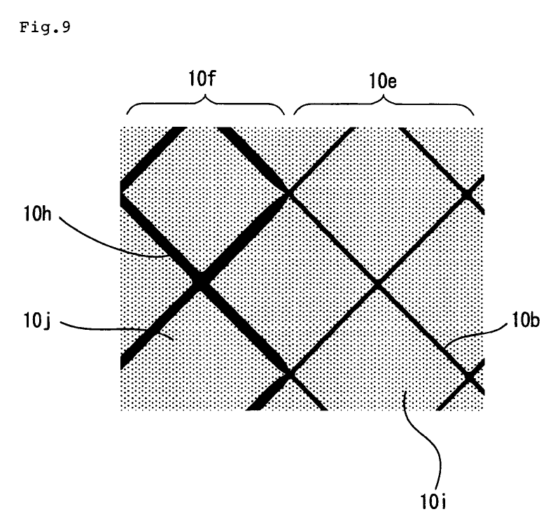

As shown as an enlarged view in FIG. 9, the letter part 10f is constructed from a electrically conductive part (thick band) 10h of a electrically conductive wire with a wider width than that of the electrically conductive wire of the mesh section 10e and the aperture surface area of an aperture part 10j in the letter part 10f is adjusted to be smaller than the aperture surface area of the aperture part 10i of the mesh section 10e, so that the light transmittance is changed and accordingly, the boundary of the mesh section 10e and the letter part 10f is emphasized to make the latter part 10f outstanding.

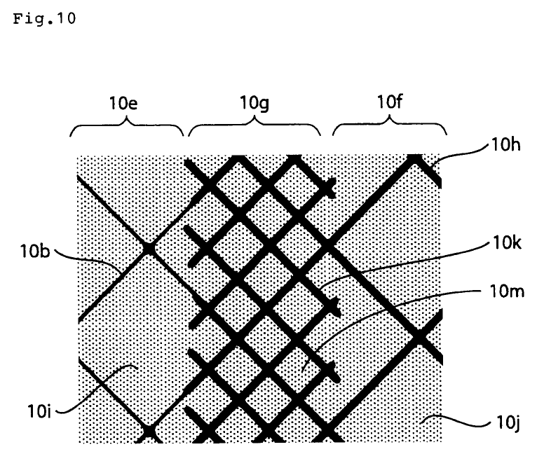

On the other hand, the letter shadow part 10g shown in FIG. 8 has the same width as that of the electrically conductive wire of the letter part 10f as being seen in further enlarged view of FIG. 10, however it is configured using the electrically conductive part 10k in a mesh pattern further smaller than the letter part 10f and thus the aperture surface area of an aperture part 10m in the letter shadow part 10g is adjusted to be smaller than the aperture surface area of the aperture part 10j in the letter part 10f, so that the letter shadow part 10g can be emphasized. The aperture surface area of an aperture part 10m in the letter shadow part 10g is set to be about ¾ to ¼ of the aperture surface area of the letter part 10f.

The letter part 10f and the letter shadow part 10g have a function as a recognition patter for recognizing a part of the antenna pattern by decreasing a prescribed quantity of the light passing through the meshes.

Accordingly, as shown in FIG. 8, the letter part 10f is formed in dark mesh pattern on the pale color mesh section 10e and the letter shadow part 10g in a dense mesh pattern is formed in the right side of the letter section 10f.

As a result, the designed logo 10d can be clearly outstandingly seen on the mesh section 10e.

Moreover, the logo 10d formed in the above-mentioned manner keeps the mesh pattern having the aperture parts with difference in the thickness and density and therefore, no light transmitting property is lost.

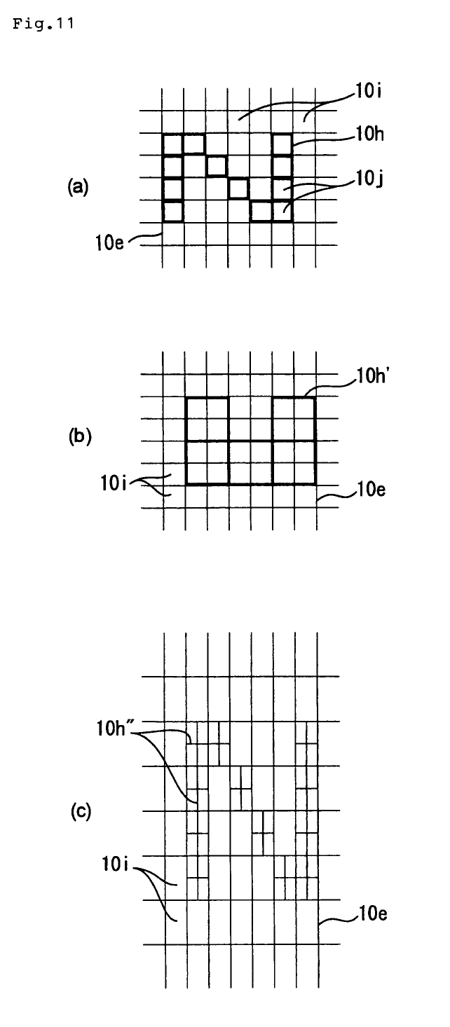

FIGS. 11 to 13 show various kinds of formation methods of the recognition patterns.

FIG. 11(a) shows each mesh of the mesh section 10e as a unit and an electrically conductive part 10h constructed from an electrically conductive wire with a width thicker than that of the electrically conductive wire of the mesh section 10e to emphasize the logo “N”.

FIG. 11(b) shows a plurality of meshes (four meshes in this drawing) as a unit and a electrically conductive part 10h′ formed in the meshes using a electrically conductive wire with a width thicker than that of the electrically conductive wire of the mesh section 10e to emphasize the U-shape logo.

FIG. 11(c) shows a single mesh divided into a plurality of meshes (four divided sections in this drawing) as a unit and a electrically conductive part 10h″ in a cross formed in the mesh to emphasize the logo “N”.

FIG. 12 shows the logo “S” in a state that the letter pattern 10n is shifted to a part of the mesh section 10e having an aperture part 10i with a square shape: and the square shape composing the latter pattern 10n is made to have the same size as the square shape composing the mesh section 10e and moved in parallel along the diagonal direction of the aperture part 10i in the mesh section 10e.

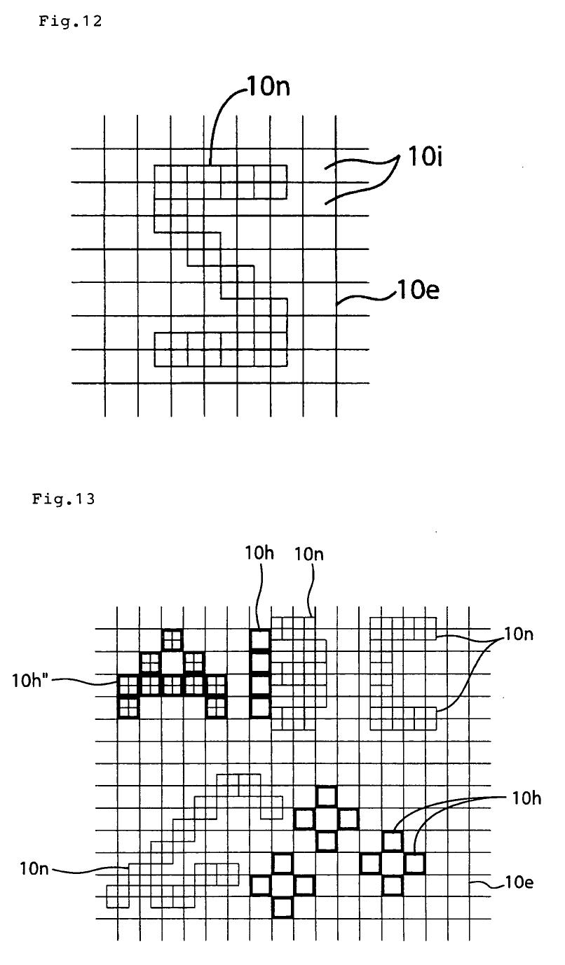

FIG. 13 shows combination of the emphasizing method illustrated for FIG. 11 and the emphasizing method by shifting illustrated for FIG. 12. If various kinds of emphasizing methods are employed as described, not only letters but also designed patterns can be arbitrarily expressed.

In the above-mentioned embodiment, the letter patterns are formed continuously on the antenna pattern, however if the letter patterns can be recognized as letters, the letter patterns may be formed intermittently by, for example skipping one mesh.

Next, production process of a transparent antenna of the present invention on which letters or patterns are designed will be described.

### EXAMPLE 3

A 125 μm-thick transparent polyester film and a 18 μm-thick copper foil were laminated through an adhesive and a transparent pressure sensitive adhesive layer was formed on a face opposite the copper foil of the polyester film.

Next, after liquid-like photoresist was applied to the copper foil face, exposure was carried out using a photomask.

The photomask had an antenna pattern mainly having aperture parts in a square lattice (20 μm in line width of the electrically conductive section, 500 μm in wiring pitches of the electrically conductive section) and a different square lattice (40 μm in line width of the electrically conductive section, 500 μm in wiring pitches of the electrically conductive section) with a different aperture ratio was formed in a part of the antenna pattern along a letter shape.

The antenna pattern having the above-mentioned square lattices with different aperture ratios was produced on the basis of CAD data inputted by a personal computer, using an automatic drawing apparatus.

Next, the resist on parts other than the antenna pattern was removed using developer solution by a conventionally known development treatment and further etching was carried out and resist removal was carried out using a stripping solution to form a letter shape design on the antenna pattern.

In the translucent antenna produced in the above-mentioned manner, it was confirmed that the square lattices (see reference symbol 10h) with different aperture ratios as shown in FIG. 11(a) appeared and that the latter formed on the antenna pattern was integrated with the antenna pattern and was excellent in a design. Further, with respect to the square lattice (reference symbol 10h) parts with different aperture ratios, since the translucency was reliably maintained, the transparency was good.

### EXAMPLE 4

After a transparent anchor layer in which an electroless plating catalyst was dispersed was formed on a 100 μm-thick transparent polycarbonate film, electroless plating and electroplating was carried out to obtain a 5 μm-thick electrically conductive layer and form low-reflection layers on both faces.

Thereafter, photoresist was applied and exposure was carried out using a photomask.

The photomask had an antenna pattern mainly having aperture parts in a square lattice (30 μm in line width of the electrically conductive section, 800 μm in wiring pitches of the electrically conductive section) and a square lattice (30 μm in line width of the electrically conductive section, 800 μm in wiring pitches of the electrically conductive section) was moved in parallel to a part of the antenna pattern to form a pattern along a letter shape.

Next, a conventionally known development treatment, etching, and resist removal were carried out to design the letter shape in the antenna pattern.

In the translucent antenna produced in the above-mentioned manner, it was confirmed that letters appeared in the state that the square lattices (see reference symbol 10n) with different aperture ratios as shown in FIG. 12 and as a result, the translucent antenna with good transparency and excellent design was obtained.

### EXAMPLE 5

After a transparent anchor layer in which an electroless plating catalyst was dispersed was formed on a 125 μm-thick transparent polyester film, electroless plating and electroplating was carried out to obtain a 4 μm-thick electrically conductive layer.

Thereafter, photoresist was applied and exposure was carried out using a photomask.

The photomask had a pattern mainly having aperture parts in a rectangular lattice (20 μm in line width of the electrically conductive section, wiring pitches of electrically conductive section: 500 μm in transverse direction×900 μm in vertical direction) and a pattern along a letter shape was formed in a part of the antenna pattern with a square lattice (20 μm in line width of the electrically conductive section, wiring pitches of electrically conductive section: 250 μm in transverse direction×450 μm in vertical direction) having a changed aperture ratio by dividing a single rectangular lattice into 4 parts.

Next, a conventionally known development treatment, etching, and resist removal were carried out to design the letter shape in the antenna pattern. As a result, a translucent antenna with good transparency and excellent design was obtained.

### EXAMPLE 6

A design with a letter shape was formed on an antenna pattern in the same manner as Example 3 by carrying out conventionally known etching treatment and resist removal, except that printing resist was used and patterning was carried out using an antenna pattern mainly having aperture parts in a square lattice (30 μm in line width of the electrically conductive section, 500 μm in wiring pitches of the electrically conductive section) and a screen plate having letter shape in a square lattice (100 μm in line width of the electrically conductive section, 500 μm in wiring pitches of the electrically conductive section) with different aperture ratio on a part of the antenna pattern. As a result, although the pattern formation precision was decreased as compared with that by the photoresist method shown in above-mentioned Examples 3 to 5, a translucent antenna with good transparency and excellent design was easily obtained.

According to the above-mentioned second embodiment, while maintaining the light transmittance and antenna performance, the transparent antenna excellent in the design property can be provided.

### (c) Third Embodiment of the Present Invention

A transparent antenna shown as the third embodiment is made to harmonize transparent antenna and front glass while maintaining the light transmittance and antenna performance.

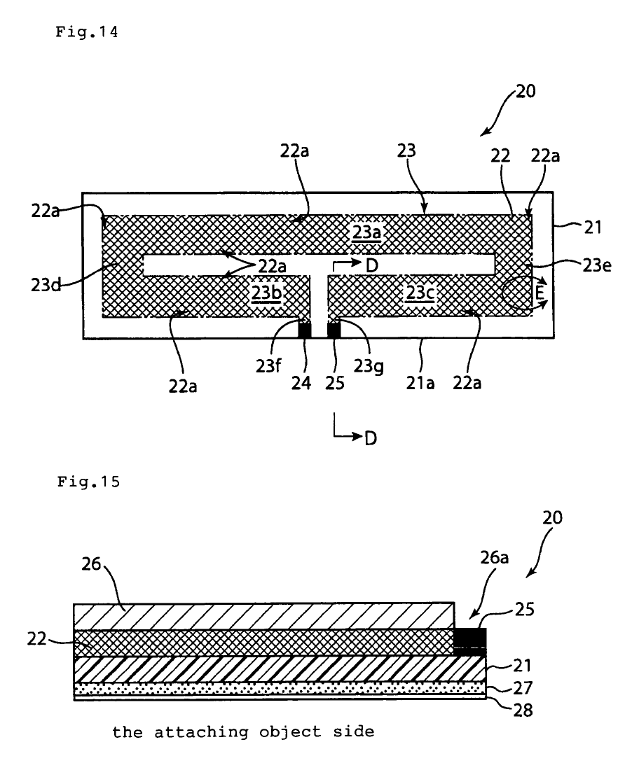

In a transparent antenna 20 shown in FIG. 14, an antenna pattern 23 was formed planarly as an electrically conductive section 22 on a transparent plastic sheet 21.

The antenna pattern 23 is constructed from a band-like pattern 23a formed longitudinally in almost entire length of the transparent plastic sheet 21, band-like patterns 23b and 23c arranged at a distance and in parallel to the band-like pattern 23a, connection parts 23d and 23e for connecting the band-like patterns 23a and 23b as well as the band-like patterns 23a and 23c, respectively, and lead parts 23f and 23g extended toward a lower rim 21a of the transparent plastic sheet 21 from the opposed band-like patterns 23b and 23c, and antenna terminals 24 and 25 are attached to the tip ends of the respective lead parts 23f and 23g.

The meshes in the electrically conductive section 22 are composed by regularly continuing geometric designs with same size and same shape and the transmittance of light passing through the electrically conductive section 22 can be controlled by changing the setting of the aperture surface area of the meshes.

The above-mentioned antenna terminals 24 and 25 are for sticking an electric power supply part of an antenna cord, which is not shown and the antenna terminals 24 and 25 are constructed from a square sheet electrically connected with the electrically conductive section 22.

FIG. 15 is a cross-sectional view along the line D-D in FIG. 14.

In the drawing, the electrically conductive section 22 of a mesh structure is formed on the transparent plastic sheet 21 and the electrically conductive section 22 is covered with a transparent protection film 26.

A through hole part 26a is formed in a part of the transparent protection film 26 and the antenna terminal 25 is exposed to the through hole part 26a. The electric power supply part of the antenna cord is stuck to the exposed antenna terminal 25.

Reference numeral 27 denotes a transparent pressure sensitive adhesive layer and reference numeral 28 denotes a separating sheet.

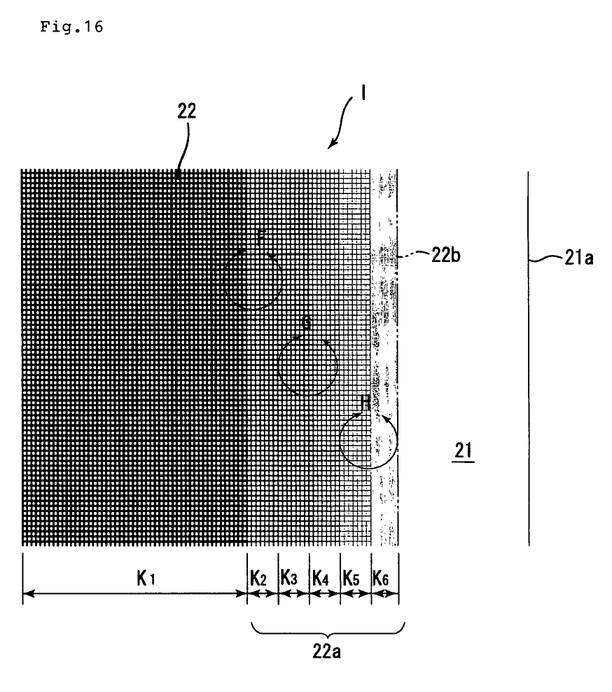

FIG. 16 is an enlarged view of an E part in FIG. 14, that is the boundary region of the antenna pattern 23 and the transparent plastic sheet 21, which is an antenna pattern non-formation section.

With respect to FIG. 16, in a boundary region I, a gradation section 22a for decreasing the luminance difference between the antenna pattern 23 and an antenna pattern non-formation section is formed.

In the drawing, reference symbol K₁ denotes an electrically conductive section region forming the antenna pattern. Reference symbol K₂ denotes a first region with slightly brighter tone (higher light transmittance) than the electrically conductive section region K₁ in the gradation section 22a formed in the outer rim portion of the electrically conductive section region K₁; reference symbol K₃ denotes a second region with further brighter tone than the first electrically conductive section region K₂; reference symbol K₄ denotes a third region with further brighter tone than the second electrically conductive section region K₃; reference symbol K₅ denotes a fourth region with further brighter tone than the third electrically conductive section region K₄; and reference symbol K₆ denotes a fifth region with further brighter tone than the fourth electrically conductive section region K₅.

The light transmittance of the fifth electrically conductive section region K₆ is approximately close to the light transmittance of the transparent plastic sheet 21.

In the drawing, reference numeral 22b denotes the outermost periphery edge of the gradation section 22a and reference numeral 21a shows the right rim of the transparent plastic sheet 21.

The light transmittance, which is a gauge of the transparency, means the total luminous transmittance for the quantity of the total luminance of light with entire wavelength emitted from a light source having a specified color temperature and transmitted through a sample face. If the light transmittance is lower than 70%, when the transparent antenna 20 is attached, for example, to the front glass of an automobile, the difference between the light transmittance of the front glass and the light transmittance of the transparent antenna 20 becomes wide to make the antenna pattern of the transparent antenna 20 seen dark. Therefore, the existence of the antenna becomes an obstacle. If it interferes in the driver's visibility of the front glass, safety is diminished.

The above-mentioned light transmittance is measured using a spectroscopic analyzer (model number NDH 2000) manufactured by Nippon Denshoku Industries Co., Ltd. Also, the light transmittance 100% in an air layer is defined as the standard.

In the case where the transparent protection film 26 is formed in the transparent antenna 20, the measurement of the light transmittance is carried out in the state that the transparent protection film 26 is included and in the case where the transparent pressure sensitive adhesive layer 27 is formed, the measurement is carried out in the state that the transparent pressure sensitive adhesive layer 27 is included.

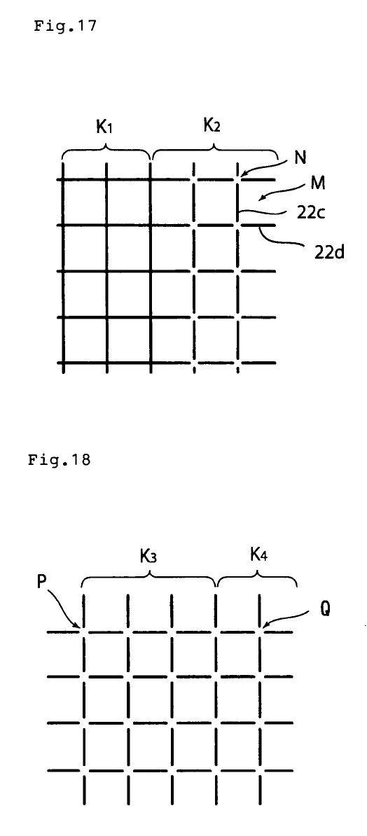

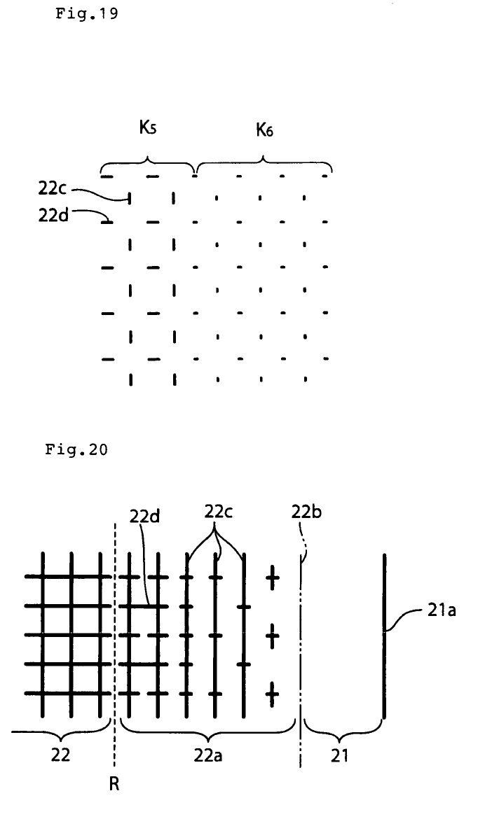

FIG. 17 is an enlarged view of an F part in FIG. 16; FIG. 18 is an enlarged view of a G part in FIG. 16; and FIG. 19 is an enlarged view of an H part in FIG. 16.

At first, in FIG. 17, the first region K₂ formed in the outside of the electrically conductive section region K₁ loses all of the crossing points of the vertical direction electrically conductive wire 22c forming the lines of the mesh and the transverse direction electrically conductive wire 22d and in such a manner, formation of the crossing point-lost section N increases the light transmittance than that in the conducive part region K₁.

The wire width w of the vertical direction electrically conductive wire 22c and the transverse direction electrically conductive wire 22d is made to be 30 μm width or thinner. If the wire width w exceeds 30 μm, the meshes of the antenna pattern become outstanding and the design is also worsened. If the wire width w is 30 μm or thinner, the existence of the antenna pattern is hardly recognized. Additionally, if the film thickness of the electrically conductive wire is controlled to give the aspect ratio of the wire width/film thickness t of 0.5 or higher, production of an antenna pattern with a good precision is made easy.

In this embodiment, the light transmittance of the transparent antenna 20 is adjusted to keep 70% or higher light transmittance by selecting combination of the wire width of the vertical direction electrically conductive wire 22c and the transverse direction electrically conductive wire 22d and aperture size of the meshes formed by surrounding with these electrically conductive wires 22c and 22d.

In FIG. 18, the second region K₃ formed in the outside of the first region K₂ has a wider lost range of the crossing point of the vertical direction electrically conductive wire 22c and the transverse direction electrically conductive wire 22d than the above-mentioned crossing point-lost section N and formation of such a crossing point-lost section P increases the light transmittance than that in the electrically conductive section region K₁.

On the other hand, the third region K₄ formed in the outside of the second region K₃ has a wider crossing point-lost section Q than the crossing point-lost section P.

In the fourth region K₅ shown in FIG. 19, a part of the vertical direction electrically conductive wire 22c and a part of the transverse direction electrically conductive wire 22d exist while keeping the directionality and the mesh shape is lost.

In the fifth region K₆, a part of the vertical direction electrically conductive wire 22c and a part of the transverse direction electrically conductive wire 22d exist in island-like dotted state while scarcely keeping the directionality.

In such a manner, due to the gradation section 22a having the luminous tone gradually increased step by step (5 grades in this embodiment) from the electrically conductive section 22, the boundary part of the antenna pattern 23 and the transparent plastic sheet 21 is hardly noticeable and the existence of the antenna pattern 23 itself can be made also unnoticeable.

FIG. 20 to FIG. 23 show modification examples of the gradation section 22a.

At first, with respect to the gradation section 22a shown in FIG. 20, the gradation provided with light transmittance is formed by leaving the vertical direction electrically conductive wire 22c and eliminating a plurality of points in the right side end portion of the transverse direction electrically conductive wire 3d. In the drawing, reference symbol R denotes a boundary of the electrically conductive section 22 and the gradation section 22a: reference symbol 22b denotes the outermost periphery rim of the gradation section 22a: and 21 denotes a transparent plastic sheet, respectively.

With respect to the gradation section 22a shown in FIG. 21, contrary to FIG. 20, the gradation provided with light transmittance is formed by leaving the transverse direction electrically conductive wire 22d and eliminating a plurality of points of the vertical direction electrically conductive wire 22c.

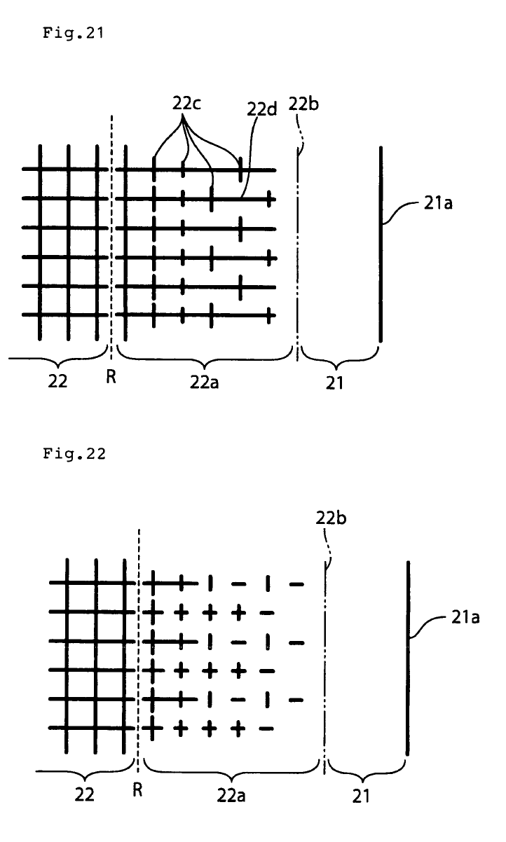

With respect to the gradation section 22a shown in FIG. 22, the techniques of FIG. 20 and FIG. 21 are combined and gradation provided with light transmittance is formed by eliminating a plurality of points in part of the transverse direction electrically conductive wire 22d and the vertical direction electrically conductive wire 22c respectively.

Although the light transmittance of FIG. 20 and FIG. 21 is approximately same, the light transmittance of FIG. 22 becomes high as compared with that of FIG. 20 and FIG. 21.

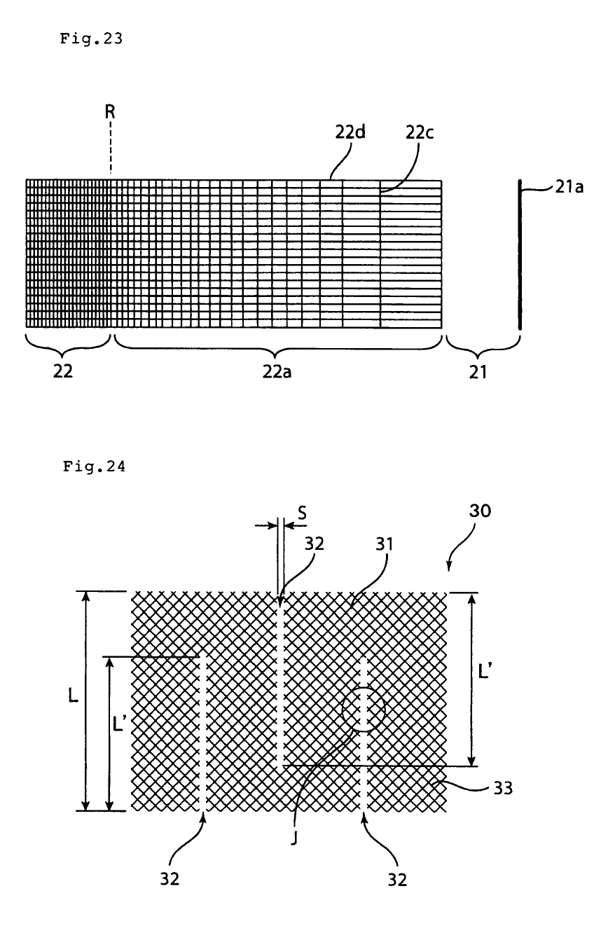

In the embodiments shown in FIG. 20 to FIG. 22, gradation is formed by eliminating the electrically conductive wires, and on the other hand, as shown in FIG. 23, the gradation section 22a may be formed by coarsening the meshes, in particular, widening the intervals of vertical direction electrically conductive wire 22c forming the meshes step by step toward the transparent plastic sheet.

According to the gradation section 22a, although the gradation effect is low as compared with that by the above-mentioned elimination of the electrically conductive wires, the gradation section 22a has an advantageous that the part is also made usable as an antenna.

Next, the production process of a transparent antenna 20 having the gradation section 22a of the present invention will be described.

### EXAMPLE 7

A 100 μm-thick transparent polyester film and a 18 μm-thick copper foil were laminated using an adhesive and a transparent pressure sensitive adhesive layer was formed on a face opposite the copper foil of the polyester film.

Next, after liquid-phase photoresist was applied to the copper foil face, exposure was carried out using a photomask.

The photomask had an antenna pattern mainly having aperture parts in a square lattice (20 μm in line width of the electrically conductive section, 500 μm in wiring pitches of the electrically conductive wire) and a gradation section shown in FIG. 20 was formed in the rim portion of the antenna pattern

The antenna pattern having the square lattice and the gradation section was produced on the basis of CAD data inputted on a personal computer, using an automatic drawing apparatus.

Next, the resist on parts other than the antenna pattern was removed by a conventionally known development treatment using a developer solution and further etching was carried out and resist removal was carried out using a stripping solution to form the antenna pattern having the gradation section.

The translucent antenna produced in the above-mentioned manner showed extremely natural gradation in the rim portion of the antenna pattern and it was confirmed that the boundary of the antenna pattern and the transparent plastic sheet was not recognized and the existence of the antenna pattern itself was hardly recognized.

### EXAMPLE 8

After a transparent anchor layer in which an electroless plating catalyst was dispersed was formed on a 50 μm-thick transparent polycarbonate film, electroless plating and electroplating was carried out to obtain a 5 μm-thick electrically conductive layer and form low-reflection layers on both faces.

Thereafter, photoresist was applied and exposure was carried out using a photomask.

The photomask had an antenna pattern mainly having aperture parts in a square lattice and the gradation section as shown in FIG. 21 was formed in the rim portion of the antenna pattern.

Next, etching and resist removal were carried out to form an antenna pattern having the gradation section (20 μm in wire width of the electrically conductive wire, and 80 μm in wiring pitches of the electrically conductive wire).

The translucent antenna produced in the above-mentioned manner showed extremely natural gradation in the rim portion of the antenna pattern and it was confirmed that the boundary of the antenna pattern and the transparent plastic sheet was not recognized and the existence of the antenna pattern itself was hardly recognized.

### EXAMPLE 9

After a transparent anchor layer in which an electroless plating catalyst was dispersed was formed on a 125 μm-thick transparent polyester film, electroless plating and electroplating was carried out to obtain a 4 μm-thick electrically conductive layer.

Thereafter, photoresist was applied and exposure was carried out using a photomask.

The photomask had an antenna pattern mainly having aperture parts in a rectangular lattice (10 μm in wire width of the electrically conductive wire, and wiring pitches: 600 μm in transverse direction×900 μm in vertical direction) and the gradation section as shown in FIG. 23 was formed in the rim portion of the antenna pattern.

Next, etching and resist removal were carried out to form an antenna pattern having the gradation section.

The translucent antenna produced in the above-mentioned manner showed extremely natural gradation in the rim portion of the antenna pattern and it was confirmed that the boundary of the antenna pattern and the transparent plastic sheet was not recognized and the existence of the antenna pattern itself was hardly recognized.

### EXAMPLE 10

An antenna pattern having a gradation section was formed in the same manner as Example 7 by carrying out conventionally known etching treatment and resist removal, except that printing resist was used and patterning was carried out using a screen plate in which an antenna pattern mainly having aperture parts in a square lattice (25 μm in line width of the electrically conductive wire, 1,000 μm in wiring pitches of the electrically conductive wire) was formed.

As a result, although the pattern formation precision was decreased as compared with that by photoresist method shown in above-mentioned Examples 7 to 9, a translucent antenna with gradation effect in the rim portion was easily obtained.

According to the above-mentioned second embodiment, while maintaining the light transmittance and antenna performance, the transparent antenna excellent in the design can be provided.

### (d) Fourth Embodiment of the Invention

The transparent antenna 30 shown in the fourth embodiment has needed antenna length for a compact size.

In FIG. 24, while using the antenna pattern 31 formed by continuously arranging the square meshes as an example, it will be explained. A plurality of slits 32 are formed in parallel in a part of antenna pattern 31. The respective slits 23 have length L′ shorter than the vertical direction length L of the antenna pattern 30 and formed in alternately different directions. Accordingly, the antenna pattern 31 is formed zigzag in FIG. 24. In the drawing, reference numeral 33 denotes a electrically conductive section.

FIG. 25 is an enlarged view of a J part in FIG. 24, S shows the slit width and Sa shows the mesh size. In this case, the mesh size means the diagonal line length in the mesh U.

It is preferable to set the above-mentioned slit width S in a range from 20 μm to the maximum size of the mesh and if the slit width S is less than 20 μm, production becomes difficult and if the slit width S exceeds the maximum size of the mesh, the slits are seen outstandingly and the design is worsened.

If the antenna pattern 31 snaked by forming the above-mentioned slits 32 is expanded to be straight, it is made possible to obtain the length with about ¼ of the wavelength of electric wave, for example UHF wave, to be received.

However, it is required for the arrangement of the slits to keep the slits from the crossing points of meshes U.

It is because if the slits 32 pass the crossing points 34 of the electrically conductive section 33 of the antenna pattern 31, the crossing points are continuously missed to make the existence of the slits outstandingly seen.

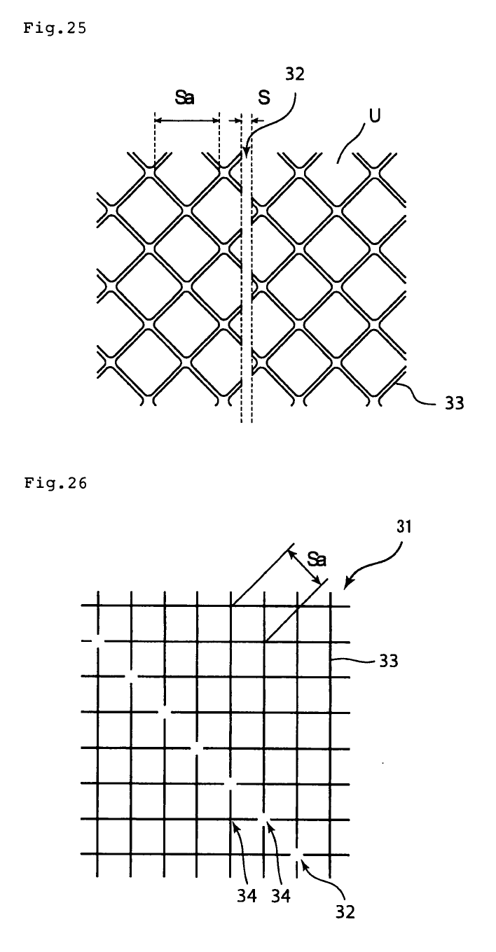

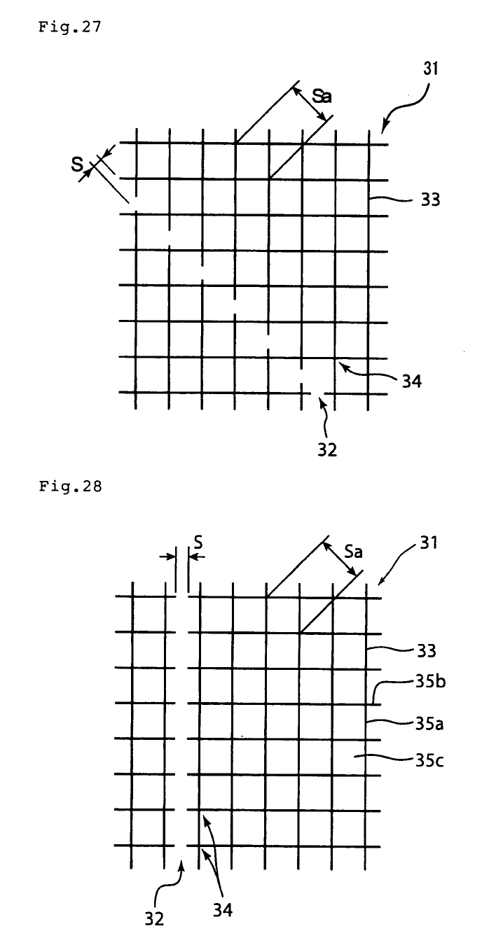

On the other hand, FIG. 27 shows slits 32 avoiding the crossing points 34 of the electrically conductive section 34. As it is made clear by comparison with that in FIG. 26, the existence of the slits 32 is not outstandingly visible.

FIG. 28 shows an antenna pattern 31 of square meshes 35c formed by arranging the vertical direction electrically conductive wire 35a and transverse direction electrically conductive wire 35b at equal intervals and slits 32 are formed along the arrangement direction of the meshes (vertical direction in this drawing) in a part of the antenna pattern 31. The slit width S is set to be about ¼ of the size Sa of the meshes 35c and the slits do not pass the crossing point, the existence of the slits is scarcely seen.

Next, the production process of a transparent antenna 30 of the present invention will be described.

### EXAMPLE 11

After a transparent anchor layer in which a plating catalyst was dispersed was formed on a 125 μm-thick transparent polycarbonate film, plating was carried out to form a 8 μm-thick electrically conductive metal layer.

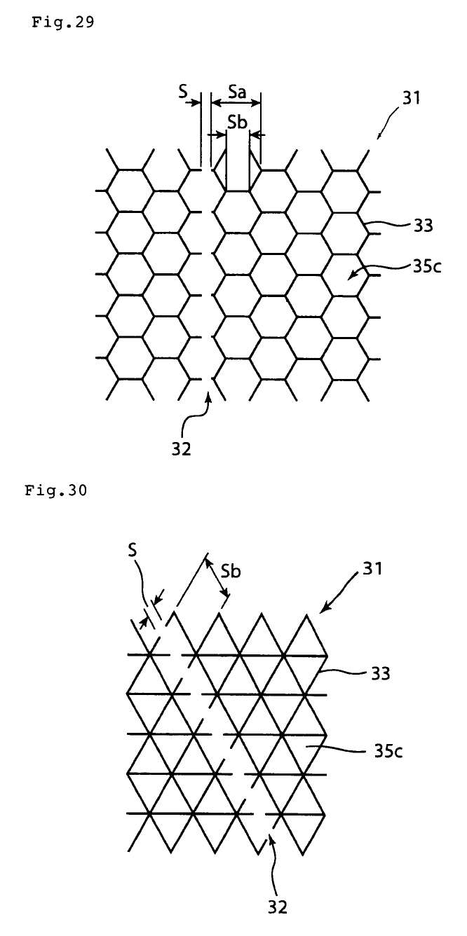

The electrically conductive metal layer was photo-etched to produce a transparent antenna as shown in FIG. 29.

In the transparent antenna, to make an aperture of the mesh 35c have a regular hexagonal shape, the wire width of the electrically conductive section 31 was set to be 12 μm and one side length Sb of the mesh 35c was set to be 600 μm and slits 32 with a width S of 100 μm were formed vertically on the antenna pattern 31.

With respect to the transparent antenna formed as described above, both of the antenna pattern 31 and the slits 32 formed on the antenna pattern 31 could not be seen. Accordingly, a transparent antenna was obtained without worsening the design.

### EXAMPLE 12

After a transparent anchor layer in which a plating catalyst was dispersed was formed on a 1 mm-thick transparent acrylic plate, plating was carried out to form a 12 μm-thick electrically conductive metal layer and an antenna pattern having slits was formed by photolithography.

Next, chemical etching was carried out to produce a transparent antenna as shown in FIG. 30.

In the transparent antenna, to make an aperture of the mesh 35c have a regular triangle shape, the wire width of the electrically conductive section 33 was set to be 20 μm and one side length Sb of the mesh 35c was set to be 900 μm and slits 32 with a width S of 80 μm were formed slantingly along mesh arrangement direction.

Further, a transparent resin coating with a thickness of 100 μm was formed as a transparent protection layer on the metal face side of the film in which the antenna pattern 31 was formed.

With respect to this transparent antenna, both of the antenna pattern 31 and the slits 32 formed on the antenna pattern 31 could not be seen. Accordingly, a transparent antenna was obtained without worsening the design.

### EXAMPLE 13

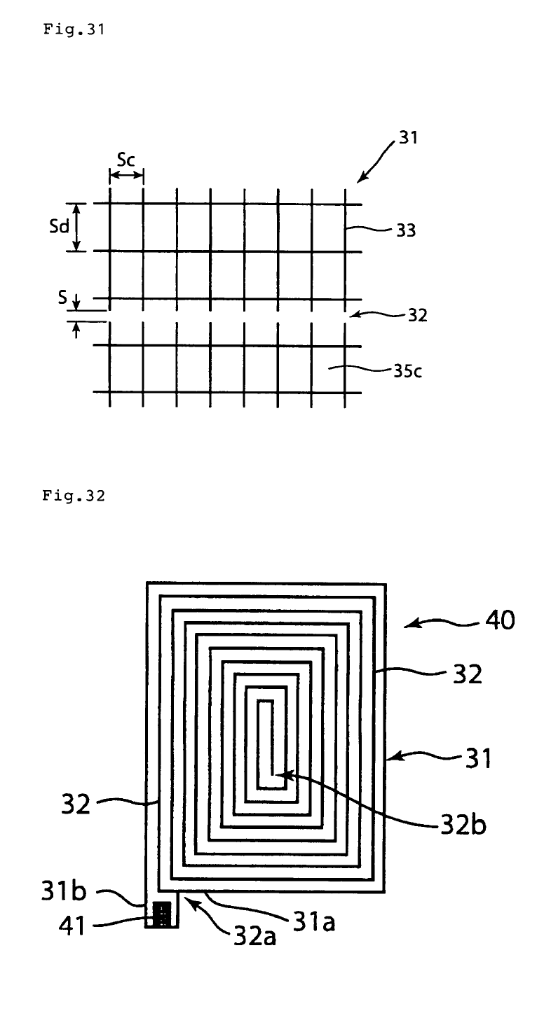

A 18 μm-thick copper foil whose both faces were chemically treated for low-reflection treatment was stuck to a 100 μm-thick transparent polyethylene terephthalate film and an antenna pattern having slits was formed by photolithography and then chemical etching was carried out to produce a transparent antenna as shown in FIG. 31.

In the transparent antenna, to make an aperture of the mesh 35c have a rectangular shape, the wire width of the electrically conductive section 33 was set to be 15 μm and the shorter side length Sc of a single mesh 35c was set to be 300 μm and the longer side length Sd was set to be 400 μm, respectively and slits 32 with a width S of 40 μm were formed transversely on the antenna pattern 31.

Next, a 100 μm-thick transparent polyethylene terephthalate film coated with a pressure sensitive adhesive as a transparent protection layer was stuck to the metal face side of the film on which the antenna pattern 31 was formed.

With respect to this transparent antenna, both of the antenna pattern 31 and the slits 32 formed on the antenna pattern 31 could not be seen and a transparent antenna was obtained without worsening the design.

### EXAMPLE 14

An antenna pattern having slits was formed by high precision printing using a silver nano-particle paste on a 800 μm-thick transparent polycarbonate plate to produce a transparent antenna having a 10 μm-thick electrically conductive layer as shown in FIG. 27.

In the transparent antenna, to make an aperture of the mesh 35c have a square shape, the wire width of the electrically conductive section 33 was set to be 30 μm and one side length Sa of a single mesh 35c was set to be 1 mm and slits 32 with a width S of 150 μm were formed slantingly at an angle of 45° to the mesh 35c on the antenna pattern 31.

With respect to this transparent antenna, both of the antenna pattern 31 and the slits 32 formed on the antenna pattern 31 could not be seen and a transparent antenna was obtained without worsening the design.

### EXAMPLE 15

After a transparent anchor layer in which a plating catalyst was dispersed was formed on a 50 μm-thick transparent polyethylene terephthalate film, copper plating was carried out to form a 5 μm-thick electrically conductive metal layer.

A resist film was formed on the electrically conductive metal layer and an antenna pattern having slits was formed by photolithography.

The resulting film was chemically etched using an iron chloride solution and the resist was peeled to produce a transparent antenna as shown in FIG. 29.

In the transparent antenna, the wire width of the electrically conductive section 33 having the mesh in a regular hexagonal shape was set to be 10 μm and one side length Sb of the mesh 35c was set to be 900 μm and slits 32 with a width S of 500 μm were formed vertically on such a antenna pattern 31.

With respect to the transparent antenna formed in the above-mentioned, both of the antenna pattern 31 and the slits 32 formed on the antenna pattern 31 could not be seen. Accordingly, a transparent antenna was obtained without worsening the design.

### EXAMPLE 16

A 12 μm-thick copper foil whose both faces were chemically treated for low-reflection treatment was stuck to a 2 mm-thick transparent glass plate to form a electrically conductive metal layer.

A resist film was formed on the electrically conductive metal layer and an antenna pattern having slits was formed by photolithography. Successively, chemical etching was carried out using a cupric chloride solution and the resist was peeled to produce a transparent antenna as shown in FIG. 30.

In the transparent antenna, the wire width of the electrically conductive section 33 having the mesh in a regular triangle shape was set to be 18 μm and one side length Sb of the mesh 35c was set to be 700 μm and slits 32 with a width S of 300 μm were formed slantingly along the arrangement direction of the mesh 35c on such a antenna pattern 31.

With respect to the transparent antenna formed in the above-mentioned, both of the antenna pattern 31 and the slits 32 formed on the antenna pattern 31 could not be seen. Accordingly, a transparent antenna was obtained without worsening the design.

### EXAMPLE 17

A 12 μm-thick copper foil whose both faces were chemically treated for low-reflection treatment was stuck to a 200 μm-thick transparent acrylic film to form a electrically conductive metal film.

A resist film was formed on the electrically conductive metal layer and an antenna pattern having slits was formed by photolithography. Successively, chemical etching was carried out using a cupric chloride solution and the resist was peeled to produce a transparent antenna as shown in FIG. 28.

In the transparent antenna, the wire width of the electrically conductive section 33 having the mesh in a square shape was set to be 15 μm and one side length Sa of the mesh 35c was set to be 1 mm and slits 32 with a width S of 1 mm were formed vertically to the mesh 35c on such a antenna pattern 31.

With respect to the transparent antenna formed in the above-mentioned, both of the antenna pattern 31 and the slits 32 formed on the antenna pattern 31 could not be seen. Accordingly, a transparent antenna was obtained without worsening the design.

Next, with reference to FIG. 32 to FIG. 36, slit formation patterns in a transparent antenna will be described. The respective drawings show the state observed in a plane view.

A transparent antenna 40 shown in FIG. 32 has a rectangular antenna pattern 31 and a slit 32 is formed on the antenna pattern 31.

The slit 32 has starting point 32a of the slit at the boundary portion of the lower rim 31a of the antenna pattern 31 and a tub 31b projected from the lower rim 31a and is formed in spiral state toward the center along the outlines of the antenna pattern 31 and the approximately the center of the antenna pattern 31 is the terminal point 32b of the slit 32. In this drawing, reference numeral 41 shows an antenna terminal formed in the tub 31b.

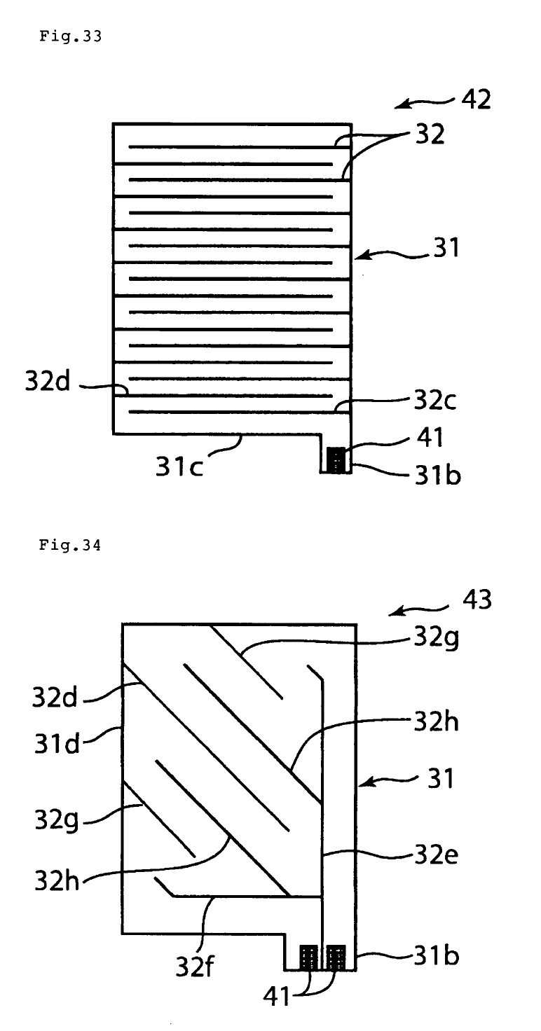

A transparent antenna 42 shown in FIG. 33 has a rectangular antenna pattern 31 and slits 32 are formed on the antenna pattern 31. Hereinafter, same symbols are assigned for the same components as those in FIG. 32 and their explanations will be omitted in the following description.

A plurality of slits 32 are formed in parallel to the shorter side 31c of the antenna pattern 31 and among a plurality of the slits 32, slits 32c are formed with a slightly shorter length than the shorter side 31c from the right rim of the antenna pattern 31 and slits 32d are formed also with a slightly shorter length than the shorter side 31c from the left rim of the antenna pattern 31. The slits 32 are formed by alternately arranging the slits 32c and the slits 32d in the vertical direction and accordingly, the antenna pattern 31 snaking in the vertical direction is formed.

A transparent antenna 43 shown in FIG. 34 has a rectangular antenna pattern 31 and provided with slits 32e extended in the vertical direction from the center of the tub 31b in the tub width direction, slits 32f branched in the transverse direction from the middle of the slits 32e, and a plurality of slits 32g and 32h formed slantingly in parallel state.

The slits 32g are formed by cutting from the lower rim of the antenna pattern 31 and formed in a prescribed length without crossing the slits 32e and 32f, on the other hand, the slits 32h are formed by cutting from the slits 32e or 32f and formed in a prescribed length without reaching the left rim 31d of the antenna pattern 31. Accordingly, the slantingly snaked antenna pattern 31 is formed within a range surrounded with the slits 32e and 32f.

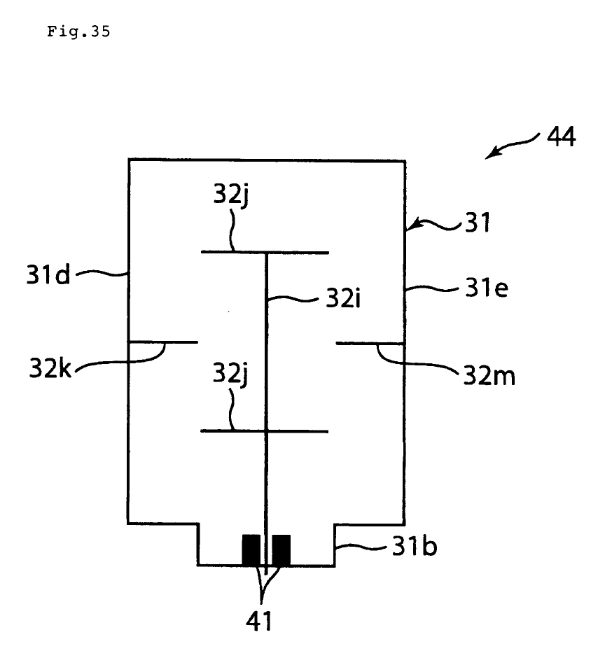

A transparent antenna 44 shown in FIG. 35 has a rectangular antenna pattern 31 and is provided with a slit 32i extended in a prescribed length from the center of the tub 31b in the tub width direction of the tub 31b, a plurality slits 32j and 32j at right angles to the slit 32i, a slit 32k formed by cutting in a prescribed length from the left rim 31d of the antenna pattern 31, and a slit 32m formed by cutting in a prescribed length from the right rim 31e.

Accordingly, antenna pattern 31 snaked in a left half and a right half of that the antenna pattern 31 are formed while having the slit 32i as the boundary.

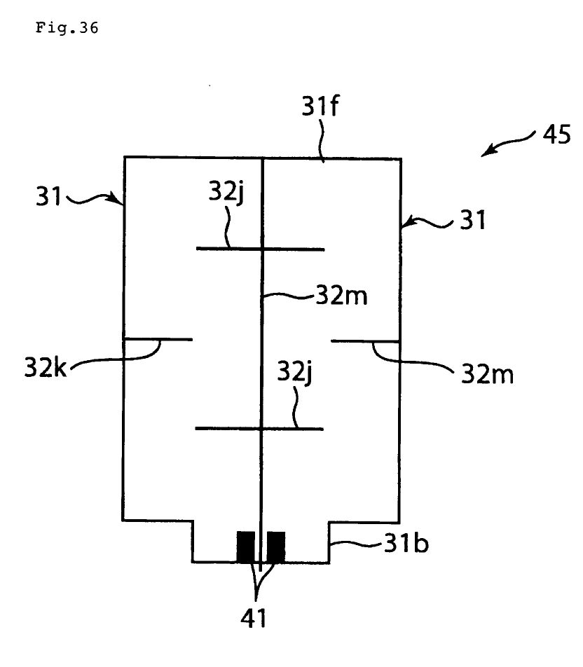

A transparent antenna 45 shown in FIG. 36 has a rectangular antenna pattern 31 and the different point of the antenna pattern from that antenna pattern shown in FIG. 35 is that the slit 32n formed in place of the 32i is extended to the upper rim 31f of the antenna pattern 31.

As described, since the antenna pattern 31 is divided right and left by the slit 32 n, these two antenna patterns 31, 31 are arranged adjacently and compose the transparent antenna.

### INDUSTRIAL APPLICABILITY

The transparent antenna of the present invention can be installed to front glass of automobiles, buses, trucks, or the like. Further, it can be installed to glass of cabins of construction machinery such as hydraulic shovels and clawer cranes. Further, it can also be installed as an antenna for communication to glass of vehicles of new traffic systems.

1. A transparent antenna for a vehicle comprising a sheet-like transparent substrate with an electrical isolation and an antenna pattern planarly formed on a surface of the transparent substrate, wherein a electrically conductive section of said antenna pattern is constructed from an electrically conductive thin film of a mesh structure and outlines of each mesh are constructed from extra fine bands having substantially equal width and the width of each of the extra fine bands is 30 mm or less and the light transmittance of said antenna pattern formation section is 70% or higher.

2. The transparent antenna for a vehicle according to claim 1, wherein said mesh structure is constructed from planar meshes regularly continuous on a plane with the same shape and size and a distinguishing pattern for distinguishing a part of said antenna pattern is formed by adding a pattern linearly in a plurality of meshes or in bands-like state to a plurality of mesh outlines in a part of said antenna pattern and thereby decreasing the light quantity passing through these meshes to be less than the light quantity passing through said antenna pattern.

3. The transparent antenna for a vehicle according to claim 2, wherein the outlines of the meshes composing said planar meshes as said distinguishing pattern is formed to be thick bands.

4. The transparent antenna for a vehicle according to claim 2, wherein said distinguishing pattern is formed by shifting a part of the mesh pattern of said mesh structure on said antenna pattern within a range not exceeding the size of a single mesh and superposing the mesh pattern on said antenna pattern.

5. The transparent antenna for a vehicle according to claim 2, wherein said distinguishing pattern is formed continuously or intermittently on said antenna pattern and accordingly forming letters and designs on said antenna pattern.

6. The transparent antenna for a vehicle according to claim 1, wherein said mesh structure is constructed from regularly continued planar meshes on a plane and a gradation section for decreasing luminance difference between said antenna pattern and a antenna pattern non-formation section on said transparent substrate is formed in the boundary region of said antenna pattern and the antenna pattern non-formation section of said transparent substrate.

7. The transparent antenna for a vehicle according to claim 6, wherein said gradation section is formed by partially eliminating the mesh outlines of said antenna pattern in said boundary region or coarsening the meshes.

8. The transparent antenna for a vehicle according to claim 6, wherein said gradation section is formed by making the length of said eliminated outlines of said meshes or the aperture width of said meshes longer step by step from said antenna pattern side to said antenna pattern non-formation section side.

9. The transparent antenna for a vehicle according to claim 6, wherein said mesh structure is composed by arranging a vertical direction electrically conductive wire and a transverse direction electrically conductive wire in a lattice-like state and said gradation section is formed by eliminating a part of at least one of the vertical direction electrically conductive wire and transverse direction electrically conductive wire or widening the intervals of the electrically conductive wire from said antenna pattern side to said antenna pattern non-formation section side.

10. The transparent antenna for a vehicle according to claim 1, wherein said antenna pattern is formed in continuous band-like state by forming slits in a part of said mesh structure and the width of said slits is adjusted not to exceed the maximum size of the mesh size.

11. The transparent antenna for a vehicle according to claim 10, wherein said antenna pattern is formed meandering shape by forming a plurality of said slits with a prescribed length alternately from different directions for said mesh structure.

12. The transparent antenna for a vehicle according to claim 10, wherein one slit is formed spirally toward the center of said mesh structure.

13. The transparent antenna for a vehicle according to claim 10, wherein the maximum size of said meshes is 1 mm.

14. The transparent antenna for a vehicle according to claim 1, wherein the shape of said meshes is composed of geometric designs.

15. The transparent antenna for a vehicle according to claim 1, wherein said antenna pattern is composed extra fine metal wires of copper or a copper alloy.

16. The transparent antenna for a vehicle according to claim 1, wherein a transparent protection film is formed on the surface of said antenna pattern.

17. The transparent antenna for a vehicle according to claim 1, wherein an electrode for electric power supply is installed in a part of said electrically conductive section and a though hole part corresponding to the electrode is formed in said transparent protection film to expose said electrode.

18. The transparent antenna for a vehicle according to claim 1, wherein the surface of said extra fine band is subjected to low-reflection treatment.

19. The transparent antenna for a vehicle according to claim 1, wherein a transparent pressure sensitive adhesive layer is formed on face of said transparent substrate in a side opposite said electrically conductive section formation side.

20. Vehicle glass with an antenna obtained by embedding a transparent antenna for a vehicle according to claim 1, equipped with an electrode for electric power supply in a part of said electrically conductive section in a bonding face of laminated glass in a state in which said electrode is projected out.
